(19) United States
(12) Patent Application Publication
(10) Pub. No.: US 2010/0181930 A1
(43) Pub. Date: Jul. 22, 2010

(54) REGULATED POWER SUPPLY

(75) Inventors: Keith Hopwood, Fremont, CA (US); Richard Frosch, Bohemia, NY (US); Predrag Hadzibabic, Bohemia, NY (US); Glen Marchiony, Bohemia, NY (US)

Correspondence Address: FISH & RICHARDSON P.C., P.O. BOX 1022, MINNEAPOLIS, MN, 55440-1022, US

(73) Assignee: Phihong USA Corp, Fremont, CA (US)

(21) Appl. No.: 12/357,987

(22) Filed: Jan. 22, 2009

(51) Int. Cl. H05B 41/36

(52) U.S. Cl. 315/297

(57) ABSTRACT

A circuit for producing a regulated output voltage and/or current includes a rectifier to rectify an alternating current (AC) input voltage and current to produce a rectified voltage and current having a frequency. A regulator is coupled to the rectifier to produce a regulated output based on the rectified voltage and/or current. A pair of output terminals supply the regulated output to a load The circuit does not include any capacitors that substantially filter the frequency of the rectified voltage and current.

### FIELD OF THE INVENTION

This invention relates to a regulated power supply and, more particularly, relates to a regulated power supply having a simple design and a long life expectancy.

### BACKGROUND

Regulated power supplies generally operate to provide a relatively controlled output voltage or output current regardless of input variations. They have a variety of applications, including as power supplies for light emitting diode based light fixtures. They have finite operating lives and their maintenance and/or replacement can be costly and difficult.

Regulated power supplies include large capacitors, such as electrolytic capacitors, to facilitate smoothing of its output voltage.

### SUMMARY OF THE INVENTION

In one aspect, a circuit for producing a regulated output voltage and/or current includes a pair of input terminals to receive an alternating current (AC) voltage and current, a rectifier coupled to the input terminals to rectify the AC voltage and current thereby producing a rectified voltage and/or current having a frequency, a regulator coupled to the rectifier to produce a regulated output and a pair of output terminals to supply the regulated output to a load.

In a typical implementation, the circuit does not include any capacitors (e.g., large electrolytic capacitors) that would substantially filter the frequency of the rectified voltage and current. Typically, therefore, the frequency of the rectified voltage and current is allowed to pass through to the regulated output. In some implementations, the circuit is arranged so that, during operation, the supplied voltage substantially includes the frequency of the rectified voltage.

In another aspect, a method of producing a regulated output includes receiving an alternating current (AC) voltage and current, rectifying the AC voltage and current to produce a rectified voltage and current having a frequency, regulating at least one of the rectified voltage and rectified current to create a regulated output. The regulated output is produced without substantially filtering the frequency of the rectified voltage and current. In a typical implementation, therefore, the frequency of the rectified voltage and current is allowed to pass to the regulated output. In some implementations, regulating produces a regulated voltage, current, or voltage and current.

The method is sometimes implemented with a circuit that does not include capacitors that filter the frequency of the rectified voltage and current. Moreover, such a circuit does not include electrolytic capacitors.

According to some implementations, the method includes filtering only high frequencies from the regulated, rectified voltage and current (e.g., those specified to be filtered to reduce electromagnetic emissions).

The frequency of the rectified voltage and current typically is twice the frequency of the AC voltage and current. Rectifying the AC voltage typically includes full wave rectifying, which produces a constant polarity waveform having a magnitude that varies over time in a substantially similar manner as an absolute value of the AC voltage's magnitude.

In a typical embodiment, the method also includes controlling the regulation with a power factor controller that is operable to control the amount of reactive power generated in producing the regulated output. In certain embodiments, regulating the rectified voltage includes switching one or more transistors, and the power factor controller controls a duty cycle associated with the switching to maintain a substantially constant phase relationship between voltage and current being delivered to the load.

In some implementations, the method includes sensing voltage and current being delivered to the load, determining average values of the sensed voltage and sensed current and controlling the regulation based on the average values of sensed voltage and sensed current. Sensing the voltage and current being delivered to the load can include isolating the signals representing the sensed voltage and current from the voltage and current being delivered to the load with one or more optical isolators.

In some embodiments, the load is a lighting device that has one or more light emitting diodes. Other loads and applications (e.g., motor controller applications) are possible as well.

In yet another aspect, a circuit for producing a regulated output includes a pair of input terminals to receive an alternating current (AC) voltage and current, a rectifier coupled to the input terminals to rectify the AC voltage and current and to produce a rectified voltage and current having a frequency, a regulator coupled to the rectifier to produce a regulated output and a pair of output terminals to supply the regulated output to a load. In some implementations, the circuit does not include any capacitors to substantially filter the frequency of the rectified voltage and current. In some implementations, the circuit is arranged so that, during operation, the supplied voltage and/or current substantially includes the frequency of the rectified voltage. The frequency of the rectified voltage and current is, in some instances, allowed to pass to the regulated output.

In various implementations, the regulated output includes a regulated voltage, a regulated current or a regulated voltage and current.

In some embodiments, the circuit is arranged and operational so that, during operation, current is drawn from at the input terminals substantially in phase with the rectified voltage. Certain implementations include one or more capacitors to filter only high frequencies for controlling electromagnetic emissions.

The rectifier may be a full-wave rectifier that produces a constant polarity waveform having a frequency twice the frequency of the AC voltage and a magnitude that varies over time in a substantially similar manner as an absolute value of the magnitude of the AC voltage.

The circuit, in some instances, includes a feedback loop with a power factor controller for controlling the regulator. The power factor controller is operable to control an amount of reactive power created in producing the regulated output. The feedback loop also can include a sensor to sense the voltage being delivered to the load, a sensor to sense the current being delivered to the load and one or more integrator circuits to determine, based on the sensed voltage and sensed current, respective average values for the sensed voltage and sensed current. The power factor controller can be arranged to control the regulator based on the average values of sensed voltage and sensed current.

In some implementations, one or more optical isolators are provided to isolate the respective voltage and current sensors from the one or more integrator circuits.

In yet another aspect, a system includes an alternating current (AC) power source, a circuit coupled to the AC power source for producing a regulated output from the AC power source voltage and a light fixture coupled to the circuit to receive the regulated voltage. The light fixture can include one or more light emitting diodes. The circuit includes a pair of input terminals to receive an alternating current (AC) voltage and current, a rectifier coupled to the input terminals to rectify the AC voltage and current and to produce a rectified voltage and current having a frequency, a regulator coupled to the rectifier to produce a regulated output based on the rectified voltage or current and a pair of output terminals to supply the regulated, rectified voltage to a load. The circuit does not include any capacitors to substantially filter the frequency of the rectified voltage and current.

In a typical implementation, the circuit is operable to pass the frequency of the rectified voltage and current to the regulated output. The regulated output can include a regulated voltage, current or voltage and current.

In some embodiments, the circuit includes one or more capacitors to filter high frequencies for control of electromagnetic emissions.

The rectifier, in some instances, is a full-wave rectifier that produces a constant polarity waveform having a frequency of twice the frequency of the AC voltage and a magnitude that varies over time in a substantially similar manner as an absolute value of the magnitude of the AC voltage.

Certain implementations of the circuit include a feedback loop with a power factor controller for controlling the regulator. The power factor controller has circuitry operable to control an amount of reactive power created by producing the regulated output. The feedback loop also can include a sensor to sense the voltage being delivered to the load, a sensor to sense the current being delivered to the load and one or more integrator circuits to determine, based on the sensed voltage and sensed current, respective average values for the sensed voltage and sensed current. The power factor controller is arranged to control the regulator, based on the average values of sensed voltage and sensed current.

In a typical embodiment, the AC power source is substantially unregulated. The system, in some implementations, includes means for protecting the load from exposure to potentially damaging current flow.

The system, including the circuit, typically does not include any capacitors that filter the frequency of the rectified voltage and current. The circuit does not include any electrolytic capacitors.

In some implementations, one or more of the following advantages are present.

For example, regulated output voltage and/or current can be supplied to a load (e.g., a light fixture having one or more light emitting diodes) substantially in phase with the absolute value of the regulator circuit's AC input voltage. The circuit operates with a high power factor and with low harmonic distortion. It is typical that the power factor is about 0.9 or higher (e.g., 0.91, 0.92, 0.93, 0.94, 0.95, 0.96, 0.97 or higher). Also, it is typical that the total harmonic distortion is below about 3% (e.g., below 2.5%, 2.0%, 1.5% or lower).

The regulator circuit does not require large capacitors such as electrolytic capacitors (including, for example, aluminum, tantalum capacitors), that tend to fail relatively quickly in service, particularly as compared to other circuit elements in a regulator circuit. Since such large capacitors are not required, the regulator circuit's size and component count can be relatively small.

In general, high efficiency can be realized over a wide range of input voltage waveforms (e.g., sine waves, square waves, etc.) while providing effectively regulated voltage and/or current at its output. The regulator circuit generally produces a small amount of heat during operation.

In general, an extended operating life can be expected. Thus, the burden associated with maintaining, repairing or replacing such regulator circuits can be reduced. This may be particularly beneficial in applications, such as street lights that use light emitting diodes, where the power supply may be in service at a location that is difficult to access.

Moreover, since the circuit itself is relatively simple, so too is the design, manufacturing and troubleshooting of the circuit as well.

The circuit typically requires very little space, since it does not require large capacitors and is generally implemented as a single stage regulator.

The regulator circuit is highly effective as a regulated power supply for applications that include light emitting diodes. Indeed, it has been found that light emitting diodes operate effectively when operated with the regulator circuit disclosed herein without any noticeable flicker. Moreover, it has been found that the regulator circuit does not harm the light emitting diodes during operation.

The regulated power supply can be operable to protect itself and its downstream circuit from damage due to exposure to unduly high stress from such natural phenomenon as lightening strikes and temperature and power fluctuations.

Typically, the regulator circuit eliminates the need for separate power factor control and DC-to-DC conversion thus significantly reducing the number of components required to produce a regulated output.

Other features and advantages will be apparent from the description and drawings, and from the claims.

### BRIEF DESCRIPTION OF THE DRAWINGS

FIG. 1 is a schematic diagram showing an exemplary regulated power supply circuit.

FIGS. 2A-2C show exemplary voltage waveforms that appear at various points in the circuit of FIG. 1 during circuit operation.

FIG. 3A-3C show measured operating parameters for a circuit similar to circuit of FIG. 1 connected to a resistive load.

FIG. 4A-4D show measured operating parameters for a circuit similar to circuit of FIG. 1 connected to a light emitting diodes fixture.

### DETAILED DESCRIPTION OF THE DRAWINGS

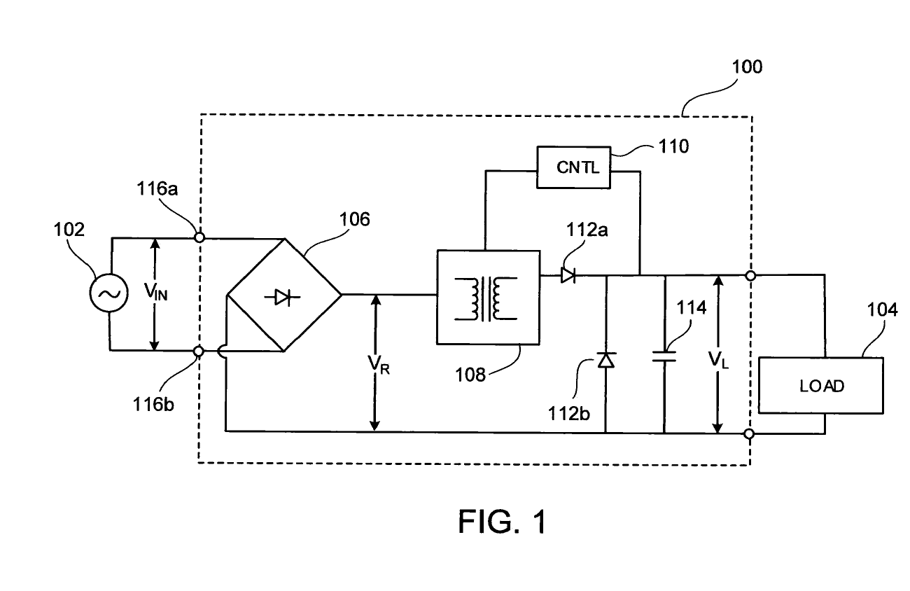

FIG. 1 is a schematic diagram showing an exemplary implementation of a regulated power supply circuit 100 connected to an unregulated alternating current (AC) power source 102 and to a load 104. In a typical implementation, the load 104 includes one or more light-emitting diodes. However, the load 104 can include any type of electrical component or combination of electrical components, whose operation might benefit from receiving regulated power.

The illustrated circuit 100 includes a rectifier 106, a regulator 108, a feedback loop with a power factor controller 110, a pair of diodes 112a, 112b (which is optional) and a high frequency output capacitor 114. The circuit 100 is generally operable to supply regulated, rectified voltage to the load 104. The voltage supplied to the load includes a low frequency component, that typically is twice the frequency of the AC power source 102 frequency. The magnitude of the voltage supplied to the load 104 varies over time in a similar manner as the absolute value of the magnitude of the AC power supply 102 voltage.

It is generally desirable that the circuit 100 be arranged and operated in such a manner that the regulated, rectified AC voltage supplied to the load 104 approximates the contours of an ideal rectified (but not filtered) AC waveform as closely as possible without too much distortion. A high level of distortion in the regulated, rectified AC voltage could result in an excessively high level of harmonic distortion associated with the circuit's 100 operation. It is generally desirable that percent total harmonic distortion (thd) be maintained below about 3% (e.g., 2.5%, 2.0%, 1.5%, etc.).

The range of low frequencies that are allowed to pass to the load 104 can vary from circuit to circuit depending on a wide range of design considerations. Typically, however, the range includes at least the frequency of the rectified voltage, which—for a full wave rectifier—is twice the frequency of the AC power source 102 frequency. In some implementations, the range of frequencies allowed to pass to the load 104 may be quite broader, including, for example, substantially all frequencies up to about ten times the line frequency, or substantially all frequencies up to about one hundred times the line frequency.

Since the frequencies about twice the AC line frequency are substantially allowed to pass to the load 104, the voltage and current delivered to the load 104 are substantially in phase with the absolute value of the circuit's 100 AC input voltage. This facilitates achieving a high power factor and low total harmonic distortion (THD).

In some implementations, the circuit 100 also is operable to limit its peak input and/or output current to help protect the circuit from becoming overloaded and destroyed or harmed by exposure to unduly high currents.

The exemplary circuit 100 of FIG. 1 is a fairly simple, single-stage regulator. It is simple to manufacture, has very few components and, therefore, is fairly compact, easy to troubleshoot, repair and maintain. The illustrated circuit 100 also has a relatively high life expectancy, at least because it does not include large capacitors, such as electrolytic capacitors, which are found in some regulators and which tend to fail relatively quickly in service, particularly as compared to the other circuit elements in regulator circuits. Also, the circuit 100 is highly efficient and tends to produce very little heat when operating. This too tends to increase the circuit's life expectancy.

The illustrated circuit 100 includes a pair of input terminals 116a, 116b that receive voltage (V_{IN}) and current from the AC power source 102. The rectifier 106 is connected to the input terminals 116a, 116b and is generally operable to convert the input AC voltage from the AC power source 102 to a rectified voltage (V_{R}) having a constant polarity at its output. The rectified voltage (V_{R}) has a magnitude that varies over time in the same way as an absolute value of the AC input voltage (V_{IN}).

In a typical implementation, the rectifier 106 is a full wave rectifier, which can include, for example, four diodes (not shown) arranged in a bridge configuration. However, other rectifier configurations, such as ones utilizing a pair of diodes and a center tapped transformer, are possible as well.

The regulator 108 is connected to the rectifier's 106 output and is generally operable to produce a regulated voltage and/or current based on the rectified voltage and/or current.

In a typical implementation, the regulator 108 is a switching regulator and includes one or more high frequency switches that switch on and off. By adjusting the duty cycle of these switches, that is the ratio of on time versus off time, the voltage, current and/or power being delivered to the load 104 can be controlled. Additionally, these switches can be operated to limit the maximum current flowing through the circuit 100.

In some embodiments, the regulator 108 is a flyback converter that includes one or more switches (e.g., transistors) and one or more inductive elements (e.g., a transformer). In such embodiments, the one or more switches operate to sequentially store and release energy from the one or more inductive elements. The switches typically have very high switching speeds ranging, for example, from about 50 kHz to about 1 MHz.

The power factor controller 110 is generally operable to control the duty cycle of the regulator's switching based on the output voltage and current from the regulator. The power factor controller may be an analog or digital circuit that is operable to control and minimize or reduce the amount of reactive power required.

There are a variety of ways in which the power factor controller can operate. In one example, the power factor controller 110 receives a pair of signals, via the feedback loop, representing load voltage and load current, respectively. The load current signal may be obtained, for example, by measuring the voltage drop across a known resistance in the power line supplying the load. In some implementations, the signal lines that deliver these signals are isolated from the power line via optical isolators (not shown in FIG. 1).

In some implementations, the power factor controller 110 integrates these signals to derive respective average values representing load voltage and load current over time. The power factor controller 110 then uses the average values to control switching in the regulator 108.

In some implementations, the power factor controller 110 also controls the regulator 108 switching to limit the load current to a predetermined maximum value to thereby protect the load. There are a number of ways in which this may be accomplished. In one example, however, current flowing either into the regulator 108 or out of the regulator 108 is sensed. The power factor controller 110 receives a signal, in some implementations over an isolated signal line, representing the sensed current. The power factor controller 110 controls the regulator's 108 switching to limit the sensed current to a predetermined maximum value.

The output capacitor 114 is provided only to filter very high frequencies (e.g., those specified to be filtered by the Federal Communications Commission (FCC) or other regulating or standards bodies and/or to avoid excessive noise). It does not filter low frequencies (e.g., frequencies at or around twice the AC power source frequency and below). The output capacitor 114 generally is a film-type capacitor or a ceramic capacitor. The exact range of frequencies that the capacitor 114 is designed to filter can vary from circuit to circuit depending on various design considerations. In various implementations, it can be sized to filter out frequencies ranging between about 150 kHz to 3 Ghz. In a typical implementation, the circuit 100 does not substantially filter frequencies below the range of frequencies that capacitor 114 is designed to filter.

In the illustrated implementation, diode 112a and (optional) diode 112b are connected to the regulator's output and help ensure that current flows in one direction only (i.e., toward the load 104) under substantially all operating conditions.

In various implementations, the circuit 100 can include a variety of other circuit components, including other capacitors, not shown in FIG. 1. If any of such other circuit elements are present, however, none would be designed to substantially filter frequencies at, near or below twice the AC power source frequency.

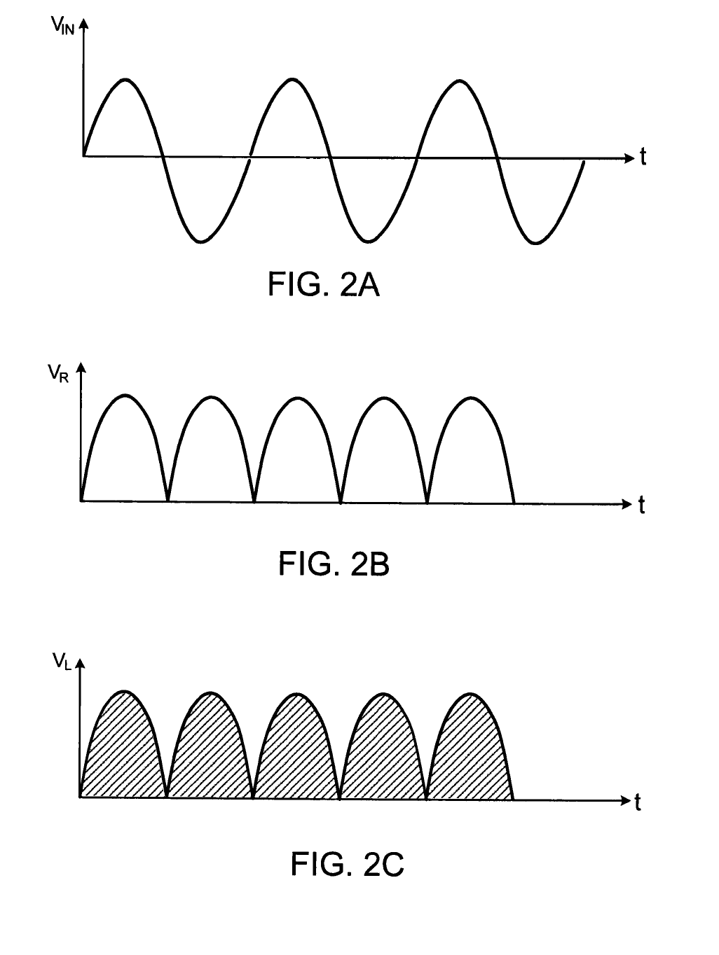

FIGS. 2A-2C show exemplary voltage waveforms that would be expected to appear at various points in the circuit of FIG. 1 when an AC power source 102 and a substantially resistive load are connected to the circuit 100. In these figures, the abscissa (x-axis) represents time (“t”) and the ordinate (y-axis) represents voltage (“V”). The time scales are the same in each figure.

As indicated above, during operation, the AC power source supplies AC voltage (V_{IN}) to input terminals at the rectifier 106. An example of the AC voltage (V_{IN}) waveform is shown in FIG. 2A. This waveform is substantially sinusoidal and is approximately what might be supplied, for example, from an electric utility company. In some implementations, particularly in the United States, this AC input (“line”) voltage would be about 120 volts and would have a frequency of about 60 Hz.

The rectifier 106 produces a rectified AC voltage having a constant polarity, an example of which is shown in FIG. 2B. The waveform in FIG. 2B is similar to the waveform of FIG. 2A, except that, in FIG. 2B the polarity of the previously negative portions of the waveform has been reversed. All portions of the illustrated waveform, therefore, are positive. The waveform produced by the rectifier has a repeating pattern with a frequency that is twice the frequency of the AC line voltage. If, for example, the AC line frequency were about 60 Hz., then the rectifier's output frequency would be about 120 Hz.

The regulator 100, diodes 112a, 112b, feedback loop with power factor controller 110 and output capacitor 114 operate to produce a regulated output voltage that has the same frequency as and is substantially in phase with the voltage produced by the rectifier. An example of this output voltage (V_{L}), which is sent to the load 104, is shown in FIG. 2C.

Since the voltage waveform of FIG. 2C is substantially in phase with an absolute value of the line voltage, the load 104 draws current substantially at the same frequency as the absolute value of the line voltage. It has been observed that for loads such as light emitting diodes, the regulated, rectified waveform typically does not cause the light emitting diodes to visibly flicker. Nor does the regulated, rectified waveform damage the light emitting diodes.

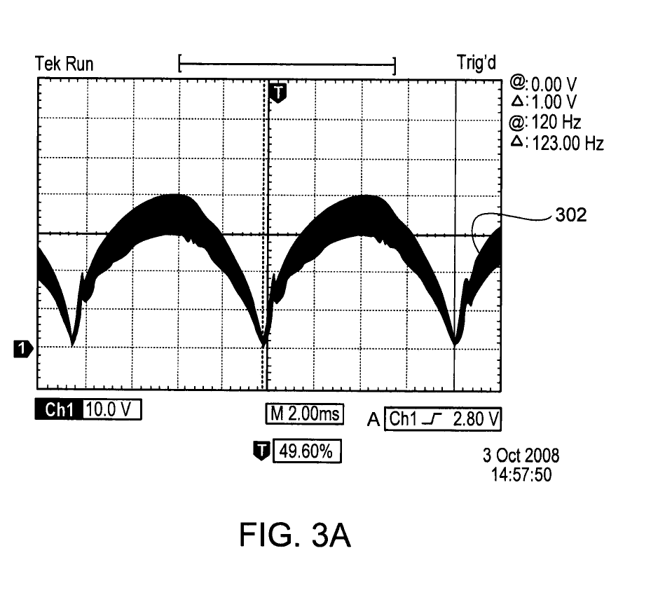

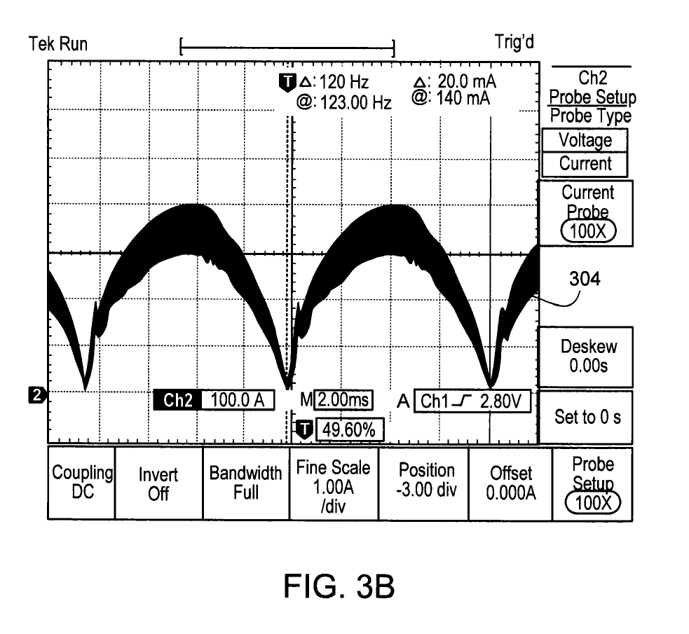

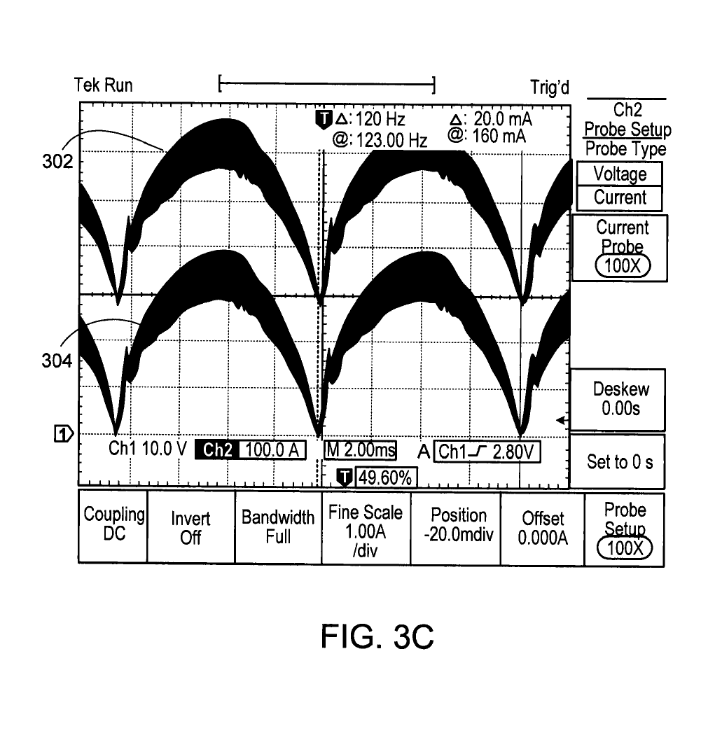

FIGS. 3A-3C show measured operating parameters for a test circuit that was similar to circuit of FIG. 1 except that the test circuit did not include diode 112b. The test circuit in this example was connected to a resistive load of about 75 watts.

More particularly, FIG. 3A is a screenshot of an oscilloscope showing measured output voltage 302, FIG. 3B is a screenshot of an oscilloscope showing measured output current 304 and FIG. 3C is a screenshot of an oscilloscope showing measured output voltage 302 and measured output current 304 plotted against the same time axis.

The output voltage 302 and output current 304 measurements were produced from a circuit that was receiving an input voltage of about 120 volt, 60 Hz. As shown in FIG. 3C, both the measured output voltage 302 and the measured output current 304 have frequencies of about 120 Hz, that is, approximately twice the frequency of the AC line voltage. As shown, the measured output voltage 302 was substantially in phase with the measured output current 304. Both the measured output voltage 302 and the measured output current 304 were approximately in phase with an absolute value of the AC line voltage.

The measured power factor was 0.939. The total harmonic distortion (Vthd %) was 1.94, with harmonics components as follows: 3^{rd}=0.48%, 5^{th}=1.65%, 7^{th}=0.9%, 9^{th}=0.33%, 11^{th}=0.42% and 13^{th}=0.45%. The measured line current was 674 milliamps.

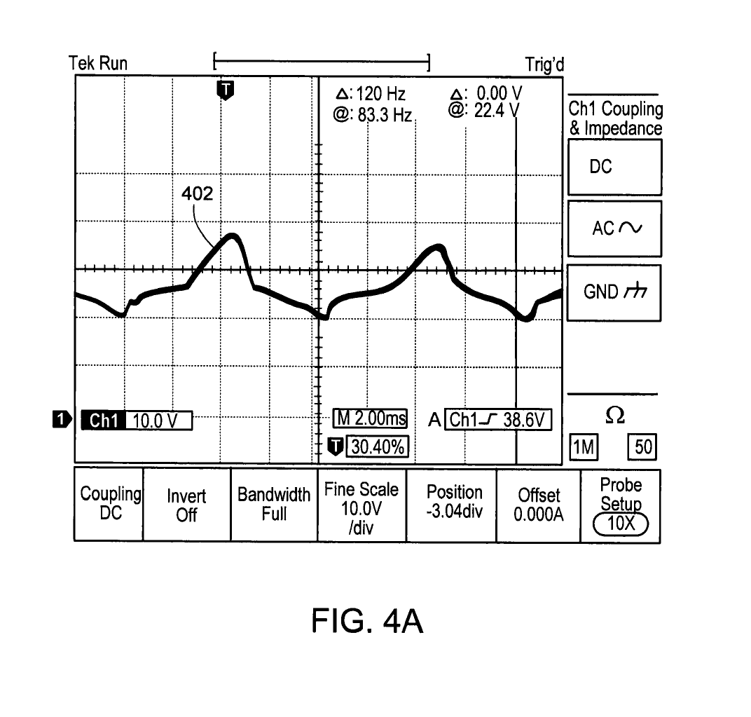

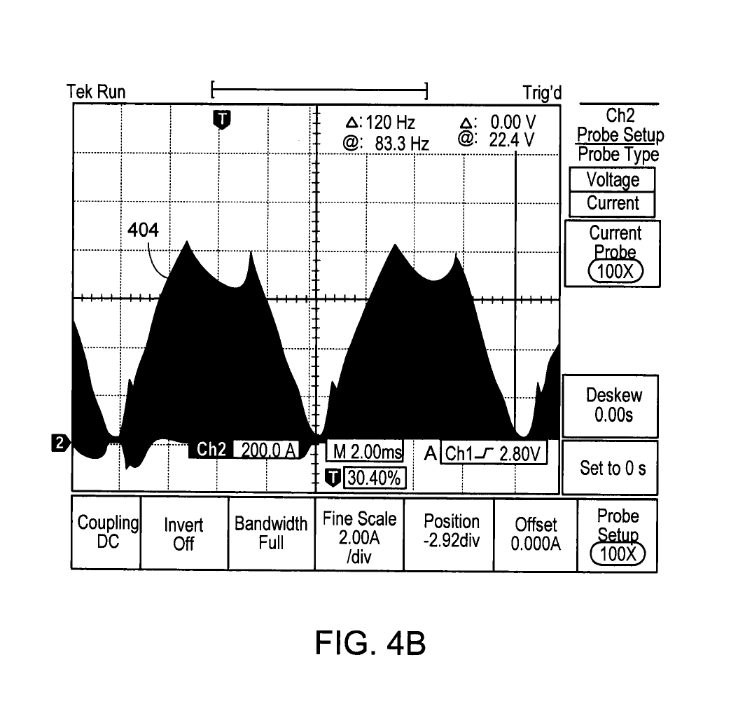

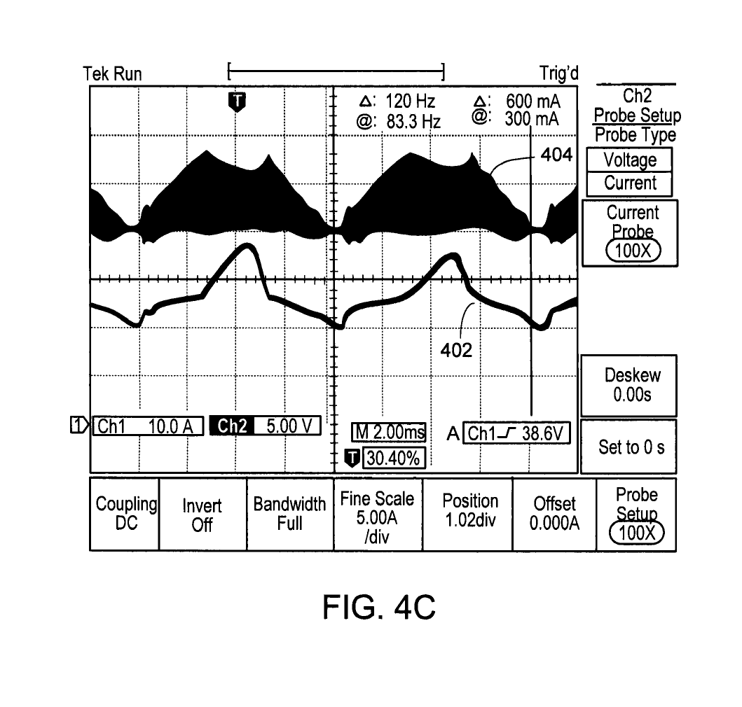

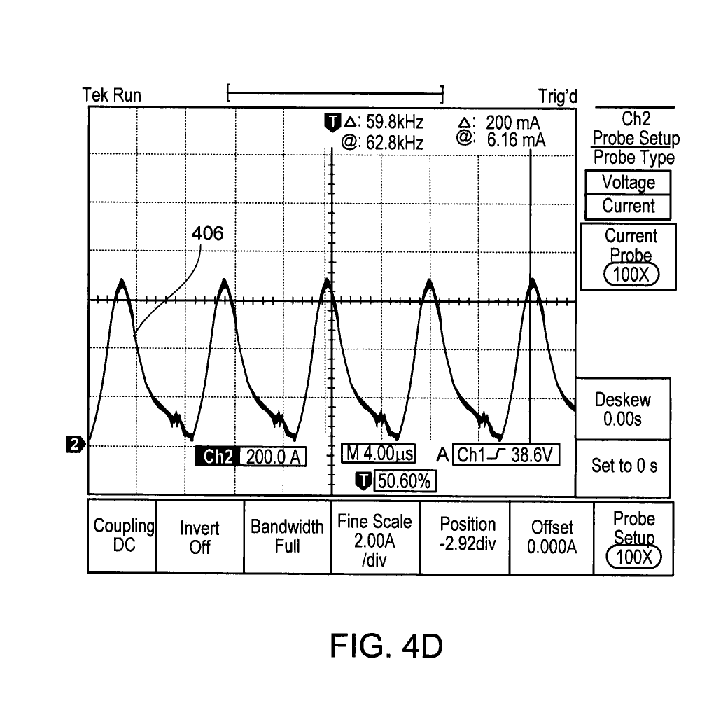

FIGS. 4A-4D show measured operating parameters for a test circuit that was similar to circuit of FIG. 1 except that the test circuit did not include diode 112b. The test circuit was connected to a light emitting diode fixture of about 75 watts as its load.

More particularly, FIG. 4A is a screenshot of an oscilloscope showing measured output voltage 402, FIG. 4B is a screenshot of an oscilloscope showing measured output current 404, FIG. 4C is a screenshot of an oscilloscope showing measured output voltage 402 and measured output current 404 plotted against the same time axis and FIG. 4D shows a high switching frequency component 406 of the output current.

The output voltage 402 and output current 404 were produced from a 120 volt, 60 Hz. AC line voltage. In the illustrated screenshot, both the measured output voltage 402 and the measured output current 404 had frequencies of about 120 Hz, that is, approximately twice the frequency of the AC line voltage. As shown, the measured output voltage 402 was substantially in phase with the measured output voltage 404. Both the measured output voltage 402 and the measured output current 404 were approximately in phase with an absolute value of the AC line voltage.

The measured power factor was 0.943. The total harmonic distortion (Vthd %) was 2.1, with harmonics components as follows: 3^{rd}=0.39%, 5^{th}=1.68%, 7^{th}=1.0%, 9^{th}=0.29%, 11^{th}=0.46% and 13^{th}=0.45%. The measured line current was 552 milliamps.

FIG. 4D shows a screenshot of an oscilloscope showing a “switching” high frequency component of output current 406 flowing into the light emitting diode load of approximately 75 watts. The illustrated screenshot shows that the switching frequency was about 60 kHz.

A number of embodiments of the invention have been described. Nevertheless, it will be understood that various modifications may be made without departing from the spirit and scope of the invention.

For example, the techniques disclosed herein may be applied to single stage isolated or non-isolated topologies. Additionally, these techniques may be applied to a variety of converter topologies including, for example, single ended primary inductor converters (SEPIC), Cuk converters, flyback converters, forward converter, and half or full bridge converters. The techniques can be applied to circuits utilizing any kind of modulation technique, such as pulse width modulation or frequency modulation.

The techniques and circuitry disclosed herein can be used to produce regulated voltage, regulated current, or regulated voltage and regulated current.

The techniques and circuitry can be used to supply regulated voltage and/or current to a variety of loads, including light emitting diode loads and motor control loads.

Additionally, one or more high frequency switches can be used in modulating the pulse width and/or the switching frequency in the regulator. In some implementations, the modulation is implemented to limit the peak and/or average load current. Limiting peak current, for example, helps protect the regulator circuit and/or the load itself from input surges. Modulation may be used to regulate output voltage and/or output current.

Other implementations are within the scope of the claims.

What is claimed is:

1. A method of producing a regulated output, the method comprising:
receiving an alternating current (AC) voltage and current;
rectifying the AC voltage and current to produce a rectified voltage and current having a frequency;
regulating at least one of the rectified voltage and rectified current to create a regulated output,
wherein the regulated output is produced without substantially filtering the frequency of the rectified voltage and current.

2. The method of claim 1 further comprising enabling the frequency of the rectified voltage and current to pass to the regulated output.

3. The method of claim 1 wherein the regulating produces a regulated voltage.

4. The method of claim 1 wherein the regulating produces a regulated current.

5. The method of claim 1 implemented with a circuit that does not include capacitors that filter the frequency of the rectified voltage and current.

6. The method of claim 1 implemented with a circuit that does not include electrolytic capacitors.

7. The method of claim 1 further comprising:
filtering high frequencies from the regulated, rectified voltage and current to reduce electromagnetic emissions.

8. The method of claim 1 wherein the frequency of the rectified voltage and current is twice the frequency of the AC voltage and current.

9. The method of claim 4 wherein rectifying the AC voltage comprises full wave rectification to produce a constant polarity waveform having a magnitude that varies over time in a substantially similar manner as an absolute value of the AC voltage's magnitude.

10. The method of claim 1 further comprising controlling the regulation with a power factor controller that is operable to control the amount of reactive power generated in producing the regulated output.

11. The method of claim 1 wherein the load is a lighting device comprising one or more light emitting diodes.

12. A circuit for producing a regulated output, the circuit comprising:
a pair of input terminals to receive an alternating current (AC) voltage and current;
a rectifier coupled to the input terminals to rectify the AC voltage and current and to produce a rectified voltage and current having a frequency;
a regulator coupled to the rectifier to produce a regulated output; and
a pair of output terminals to supply the regulated output to a load;
wherein the circuit does not include any capacitors to substantially filter the frequency of the rectified voltage and current.

13. The circuit of claim 12 wherein the frequency of the rectified voltage and current is allowed to pass to the regulated output.

14. The circuit of claim 12 wherein the regulated output is produced without substantially filtering the frequency of the rectified voltage and current.

15. The circuit of claim 12 wherein the regulated output comprises a regulated voltage.

16. The circuit of claim 12 wherein the regulated output comprises a regulated current.

17. The circuit of claim 12 wherein the circuit is arranged so that, during operation, current is drawn from at the input terminals substantially in phase with the rectified voltage.

18. The circuit of claim 12 further comprising:
one or more capacitors to filter high frequencies for controlling electromagnetic emissions.

19. The circuit of claim 12 wherein the rectifier is a full-wave rectifier that produces a constant polarity waveform having a frequency twice the frequency of the AC voltage and a magnitude that varies over time in a substantially similar manner as an absolute value of the magnitude of the AC voltage.

20. The circuit of claim 12 further comprising:
a feedback loop with a power factor controller for controlling the regulator,
wherein the power factor controller is operable to control an amount of reactive power created by producing the regulated output.

21. A system comprising:
an alternating current (AC) power source;
a circuit coupled to the AC power source for producing a regulated output from the AC power source voltage; and
a light fixture coupled to the circuit to receive the regulated voltage,
wherein the light fixture comprises one or more light emitting diodes, and
wherein the circuit comprises:
a pair of input terminals to receive an alternating current (AC) voltage and current;
a rectifier coupled to the input terminals to rectify the AC voltage and current and to produce a rectified voltage and current having a frequency;
a regulator coupled to the rectifier to produce a regulated output based on the rectified voltage or current; and
a pair of output terminals to supply the regulated, rectified voltage to a load;
wherein the circuit does not include any capacitors to substantially filter the frequency of the rectified voltage and current.

22. The system of claim 21 wherein the circuit is operable to pass the frequency of the rectified voltage and current to the regulated output.

23. The system of claim 21 wherein the regulated output comprises a regulated voltage.

24. The system of claim 21 wherein the regulated output comprises a regulated current.

25. The system of claim 21 wherein the circuit comprises:
one or more capacitors to filter high frequencies for control of electromagnetic emissions.

26. The system of claim 21 wherein the rectifier is a full-wave rectifier that produces a constant polarity waveform having a frequency of twice the frequency of the AC voltage and a magnitude that varies over time in a substantially similar manner as an absolute value of the magnitude of the AC voltage.

27. The system of claim 21 wherein the circuit further comprises a feedback loop with a power factor controller for controlling the regulator,
wherein the power factor controller comprising circuitry operable to control an amount of reactive power created by producing the regulated output.

28. The system of claim 21 wherein the circuit does not include any capacitors that filter the frequency of the rectified voltage and current.

29. The method of claim 21 wherein the circuit does not include any electrolytic capacitors.
